(19) United States
(12) Patent Application Publication
(10) Pub. No.: US 2015/0263334 A1
(43) Pub. Date: Sep. 17, 2015

(54) NON-AQUEOUS ELECTROLYTE SECONDARY BATTERY

(71) Applicant: SANYO Electric Co., Ltd., Moriguchi-shi, Osaka (JP)

(72) Inventors: Shinya Miyazaki, Hyogo (JP); Kazunori Donoue, Hyogo (JP)

(73) Assignee: SANYO Electric Co., Ltd., Moriguchi-shi, Osaka (JP)

(21) Appl. No.: 14/418,343

(22) PCT Filed: Sep. 26, 2013
(86) PCT No.: PCT/JP2013/005719

§ 371 Date: Jan. 29, 2015

(30) Foreign Application Priority Data
Sep. 28, 2012 (JP) 2012-217420

(51) Int. Cl. H01M 4/131; H01M 4/505; H01M 4/525; H01M 2/16

(52) U.S. Cl. CPC H01M 4/131; H01M 2/1686; H01M 4/505; H01M 4/525; H01M 2004/028

(57) ABSTRACT

In a non-aqueous electrolyte secondary battery having an outer case storing a stacked electrode assembly, each of positive electrode plates are provided with a positive electrode active material layer formed on a surface of a positive electrode core made of an aluminum-based metal, and the separator includes a polyolefin microporous film and a layer containing insulating metal oxide composite, and the positive electrode active material layer contains a lithium transition-metal composite oxide expressed by Liₐ(Ni_{b}Co_{c}Mn_{d}Mₑ)O₂ (0.9≦a≦1.2, 0≦b≦0.6, 0.2≦d≦0.5, 0≦e≦0.05, b+c+d+e=1) as the positive electrode active material, and a thickness X of the positive electrode active material layer and a thickness Y of the positive electrode core satisfy a relation of Y/X≦0.23, and the outer case is not electrically connected to the positive electrode plates, thereby providing the non-aqueous electrolyte secondary battery which is excellent in safety.

### TECHNICAL FIELD

The present invention is related to a safety improvement of a non-aqueous electrolyte secondary battery.

### BACKGROUND ART

Non-aqueous electrolyte secondary batteries have a high energy density and are widely used as driving power sources of portable devices. In recent years, a high functionalization of mobile information terminals, such as mobile phones, smart phones, and notebook computers, are rapidly progressing, and a battery having a higher capacity is required.

As a positive electrode active material of the non-aqueous electrolyte secondary batteries, a lithium transition-metal composite oxide including cobalt and/or nickel is widely used since it has a high capacity and excellent load characteristics. However, the lithium transition-metal composite oxide including cobalt and/or nickel has a problem that it has low thermal stability during a battery abnormality such as a short circuit.

Here, technologies related to the non-aqueous electrolyte secondary batteries are described in the following.

### CITATION LIST

### Patent Literature

Patent Literature 1: Japanese Laid-Open Patent Publication No. 2011-103249
Patent Literature 2: Japanese Laid-Open Patent Publication No. 2011-96485
Patent Literature 3: Japanese Laid-Open Patent Publication No. 2007-200795

### SUMMARY OF THE INVENTION

Patent literature 1 discloses a secondary battery including plural battery cells containing a non-aqueous electrolyte and a battery case housing the plural battery cells. The battery case has a bottom plane, side planes, and an upper lid. An elastic member is provided at a location on the bottom plane and between the adjacent plural battery cells, and the battery cells are pressed toward at least one of the side planes and the upper lid by being energized by the elastic member.

Patent literature 2 discloses a secondary battery including: a battery element containing a non-aqueous electrolyte; a positive electrode current collector foil and a negative electrode current collector foil guided out of both ends of the battery element; a positive electrode lead plate and a negative electrode lead plate which are connected to a positive electrode terminal and a negative electrode terminal respectively; and a battery case housing the battery element, the current collector foils, and the lead plates. At both sides of the battery element, elastic members are each provided between the battery element and wall surfaces in the lengthwise direction. One elastic member forms a complex in combination with the positive electrode lead plate, and the other elastic member forms a complex in combination with the negative electrode lead plate.

Then, in both technologies, as the positive electrode active material, LiNi_{0.33}Co_{0.33}Mn_{0.33}O₂ is used. According to these technologies, it is possible to provide the secondary battery having a structure improving impact resistance and vibration resistance.

In addition, patent literature 3 discloses a lithium ion secondary battery including: an electrode assembly comprises having a belt-like negative electrode plate being provided with a negative electrode mixture layer on a negative electrode core, a belt-like positive electrode plate being provided with a positive electrode mixture layer on a positive electrode core, and a separator; and an electrolyte, the electrode assembly and the electrolyte being inserted into a metal case or a metal laminate outer package. The positive electrode mixture layer has a porosity of 35 through 55%. Then, a refractory porous layer is formed on at least any one of the positive electrode mixture layer, the negative electrode mixture layer, and the separator.

According to this, it is possible to provide a lithium ion battery having higher safety, in which the occurrence of a short circuit during the use of the battery does not lead to smoking, and further having not only excellent output characteristics but also excellent input characteristics.

However, sufficient investigation has not been carried out on safety of a non-aqueous electrolyte secondary battery, with a large area and a high capacity, using a stacked electrode assembly which is formed such that a positive electrode plate and a negative electrode plate are alternatively stacked with a separator interposed therebetween.

The present disclosure is developed for solving the aforementioned problem, and aims to provide a non-aqueous electrolyte secondary battery which exhibits excellent safety and has a high capacity.

In order to solve the aforementioned problem, the present disclosure is configured as follows. A non-aqueous electrolyte secondary battery of the present disclosure includes a stacked electrode assembly in which plural positive electrode plates and plural negative electrode plates are stacked interposing separators therebetween, and an outer case housing a non-aqueous electrolyte and the stacked electrode assembly, wherein: each of the positive electrode plates are provided with a positive electrode active material layer formed on a surface of a positive electrode core made of an aluminum-based metal; the separator includes a polyolefin microporous film and a layer containing insulating metal oxide which is formed on at least one surface of the polyolefin microporous film; the positive electrode active material layer contains a lithium transition-metal composite oxide expressed by Liₐ(Ni_{b}Co_{c}Mn_{d}Mₑ)O₂ (0.9≦a≦1.2, 0≦b≦0.6, 0.2≦d≦0.5, 0≦e≦0.05, b+c+d+e=1, and M is at least one element selected from the group consisting of Ti, Nb, Mo, Zn, Al, Sn, Mg, Ca, Sr, Zr, and W) as the positive electrode active material; a thickness X of the positive electrode active material layer and a thickness Y of the positive electrode core satisfy a relation of Y/X 0.23; and the outer case is not electrically connected to the positive electrode plates.

Moreover, more preferably, the relation may be Y/X≦0.20.

Accordingly, the positive electrode active material contains the lithium transition-metal composite oxide containing manganese, and cobalt and/or nickel. As the lithium transition-metal composite oxide contains cobalt and/or nickel, it has a high capacity and excellent load characteristics and thermal stability is enhanced by manganese.

Further, the positive electrode core uses the aluminum-based metal (pure aluminum or aluminum alloy) having a low resistance and low cost, thereby exhibiting excellent current-collecting efficiency. Then, as the ratio Y/X of the thickness Y of the positive electrode core to the thickness X of the positive electrode active material layer is regulated to be 0.23 or less, safety is ensured. Here, when the thickness of the positive electrode core is relatively large compared with that of the positive electrode active material layer (Y/X is more than 0.23), a large current flow at the time of a compulsory short circuit like nail penetration results in decreased safety.

Further, the separator in the present disclosure includes the polyolefin microporous film and the insulating metal oxide layer formed on one surface of the polyolefin microporous film, and the metal oxide layer suppresses the thermal contraction of the separator. Therefore, even when the battery becomes an abnormally high temperature as in the case of the nail penetration, the insulation between the positive and negative electrode plates is ensured. Here, the polyolefin microporous film is used. When the battery temperature rises abnormally, the separator containing only the polyolefin microporous film thermally contracts. That causes the contact between the positive and negative electrode plates, resulting in decreased safety.

Here, the manner in which the metal oxide layer is formed on the surface of the polyolefin microporous film is superior compared with the manner in which the metal oxide layer is formed on the positive electrode plate or the negative electrode plate, in that a crack and a pin hole hardly occurs in the metal oxide layer and in that the layer easily enters between the electrode plates of a short circuit.

Further, when the outer case is electrically connected to the positive electrode plates, the temperature of the positive electrode plates easily increases at the time of the battery abnormality like the nail penetration. Even when the positive electrode active material contains the above lithium transition-metal composite oxide, safety is not secured. Therefore, the configuration is employed in which the outer case is not electrically connected to the positive electrode (namely, the outer case is electrically connected to the negative electrode, or the outer case has no polarity).

By the way, as structures of electrode assemblies for outputting a large current, there is a stacked electrode assembly plate-like positive and negative electrode plates are stacked interposing separators therebetween, and a spiral electrode assembly where plate-like positive and negative electrode plates are wound interposing separators therebetween. At the time of the compulsory short circuit by the nail penetration, the short-circuit current flows mainly at the portion where the nail is penetrated, and a part of the current bypasses other conducting portions to flow. The bypass current in the stacked electrode assembly flows via narrow tabs which are connected to the electrode outer terminal. In contrast, the bypass current in the spiral electrode assembly flows via wound positive and negative electrode cores. Therefore, the bypass current in the spiral electrode assembly is larger than that in the stacked electrode assembly. Safety in the nail penetration of the spiral electrode assembly is not enough, but the stacked electrode assembly provides high safety by being combined with the above positive electrode active material, the separator, and the like.

Here, in the above chemical formula of Liₐ(Ni_{b}Co_{c}Mn_{d}Mₑ)O₂, a capacity remarkably decreases when the Li content is less than 0.9, and the decrease in a capacity and the gas generation become marked when the Li content is more than 1.2. Therefore, the Li content a is regulated to 0.9≦a≦1.2. The charge and discharge efficiency easily decreases and a problem occurs in productivity when the Mn proportion content d is more than 0.5, and the thermally stabilizing effect is not enough when the Mn content d is less than 0.2. Therefore, the Mn content d is regulated to 0.2≦d≦0.5. Further, there is no particular problem when the Ni content b is 0 (zero). However, when the Ni content b exceeds 0.6, the gas is easily generated at the time of the battery abnormality and a rapid reaction occurs at the time of a short circuit. Therefore, the Ni content b is regulated to 0≦b≦0.6. Further, sufficient discharge characteristics and safety are obtained without the dissimilar element M, and therefore, the lower limit of e is 0 (zero). Also, the addition of the dissimilar element M further improves thermal stability and the like, but an excessive M content might cause the decrease of a discharge capacity. Therefore, the upper limit of e is 0.05. From the above, the sum of Ni and Co is 0.45≦b+c≦0.8.

Also, the metal oxide layer may be formed on one surface or both surfaces of the polyolefin microporous film. The metal oxide layer does not directly contribute to charging and discharging. Therefore, when its thickness is too large, a discharge capacity might be decreased. Then, when the metal oxide layer is formed only on one surface of the polyolefin microporous film, the electrode plate which the metal oxide layer composite faces may be any one of the positive electrode plate and the negative electrode plate. The thickness of the metal oxide layer is preferably 1 to 10 μm, and more preferably 2 to 7 μm. Further, the thickness of the polyolefin microporous film is preferably 10 to 50 μm, and more preferably 12 to 30 μm.

A region in each of the positive electrode plates, where the positive electrode active material layers is formed, has an area of 200 cm² or more.

In a sheet of positive electrode plate, when the area where the positive electrode active material layer is formed becomes large, a discharge capacity increases by that amount, resulting in the difficulty to ensure safety. However, since employing the configuration of the present disclosure remarkably improves safety, it is preferable that the present disclosure be applied to such battery. Here, the area of the region where the positive electrode active material layer is formed means its area (the area of the positive electrode active material layer in a plan view) in the case where the positive electrode active material layer is formed only on one surface of the positive electrode core, and the total area of both surfaces in the case where the positive electrode active material layer is formed on both surfaces of the positive electrode core.

In the plural positive electrode plates, the regions, where the positive electrode active material layer is each formed, have a total area of 4000 cm² or more.

When the area where the positive electrode active material layer is formed in all the positive electrode plates becomes large, a discharge capacity increases by that amount, resulting in the difficulty to ensure safety. However, as the configuration of the present disclosure remarkably improves safety, it is preferable that the present disclosure be applied to such battery.

Here, it is not necessary to specifically define the upper limit of the area or the total area of the region where the positive electrode active material layer is formed. However, when these areas become large, a size of the outer case becomes large by those amounts. Considering a size of the outer case determined by a use, a purpose, and the like, those areas may be determined.

The non-aqueous electrolyte contains a non-aqueous solvent, and the non-aqueous solvent may contain 40% or less by volume of ethylene carbonate to the non-aqueous solvent.

Ethylene carbonate has an effect to improve discharge characteristics, and it is preferable that the non-aqueous solvent contain this. However, since ethylene carbonate reacts with the above lithium transition-metal composite oxide to generate gas, the battery swells during high temperature storage when its content is large. Thus, it is preferable that the non-aqueous solvent contain 40% or less by volume of ethylene carbonate to the non-aqueous solvent.

The non-aqueous electrolyte may contain 0.5 to 10% by mass of fluoroethylene carbonate to the non-aqueous electrolyte.

As fuoroethylene carbonate has effects to enhance storage characteristics and cycle characteristics, it is preferable that the non-aqueous electrolyte contain 0.5 or more % by mass of fluoroethylene carbonate to the non-aqueous electrolyte. However, since fuoroethylene carbonate reacts with the above lithium transition-metal composite oxide to generate gas, the battery swells during high temperature storage when its content is large. Thus, it is preferable that the non-aqueous electrolyte contain 10 or less % by mass of fluoroethylene carbonate to the non-aqueous electrolyte.

Moreover, as the positive electrode core does not directly contribute to charging and discharging, a discharge capacity decreases when its thickness is too thick. On the other hand, when its thickness is too thin, it might break during manufacturing steps. Therefore, it is preferable that the positive electrode core have a thickness of 12 to 25 μm.

It is preferable to use a laminate material as the outer case in which a resin layer is formed on both surfaces of a metal layer since it can reliably prevent the electrical connection between the positive electrode plates and the outer case.

Moreover, the positive electrode active material may further contain a spinel type lithium manganese oxide expressed by Li_{f}Mn_{2-g} M1_{g}O₄ (0.9≦f≦1.2, 0≦g≦0.1, and M1 is at least one element selected from the group consisting of B, Mg, Ca, Sr, Ba, Ti, Ni, Al, Nb, Mo, W, Y, and Rh) with the above lithium transition-metal composite oxide. However, as the spinel type lithium manganese oxide is inferior to the above lithium transition-metal composite oxide in packability and a discharge capacity, it is preferable that the content of spinel type lithium manganite be 0 to 40% by mass to the positive electrode active material.

In addition, when the thickness of the positive electrode core is too thick, it might be difficult to form the positive electrode active material layer with an uniform thickness. Also, when the thickness of the positive electrode core is too thin, it might break during manufacturing steps. Therefore, it is preferable that the ratio Y/X of the thickness Y of the positive electrode core to the thickness X of the positive electrode active material layer be 0.05 or more.

Moreover, when the non-aqueous solvent contains ethylene carbonate, in order to obtain an improvement effect of charging characteristics by ethylene carbonate, it is preferable that the non-aqueous solvent contain 15% or more by volume of ethylene carbonate to the non-aqueous solvent.

Moreover, in Liₐ(Ni_{b}Co_{c}Mn_{d}Mₑ)O₂, even at the cobalt content c of 0 (zero), excellent performance can be obtained. However, it is more preferable that the cobalt proportion c be 0.2≦c≦0.5 since it is easy to obtain an active material with high charge-discharge efficiency and excellent cycle performance.

Moreover, the positive electrode active material may have a configuration containing plural kinds of the above lithium transition-metal composite oxides which are different in the constituent proportion of the metal elements the composition of the dissimilar elements, or the like.

Moreover, the metal oxide which configures the metal oxide layer formed on the separator is preferably at least one selected from the group consisting of alumina, silica, and titania. In addition, the metal oxide is preferably in particle-shape. Further, it is preferably that the metal oxide layer contain a binder which binds the metal oxide particles with each other and with the microporous film. As the binder, there may be used cellulose derivatives such as carboxymethyl cellulose, polyvinyl alcohol, and the like. It is preferable to form the metal oxide layer by coating slurry or paste, in which the metal oxide and the binder are dissolved or dispersed in solvent or dispersion, on the surface of the microporous film and drying it.

As explained above, according to the present disclosure, a remarkable effect is exhibited that it is possible to provide a non-aqueous electrolyte secondary battery that has a high discharge capacity and excellent safety.

### DESCRIPTION OF EMBODIMENTS

Hereinbelow, preferred embodiments of the present invention will be described in detail. The present invention is not limited to the following preferred embodiments and may be adequately changed and modified without departing from the scope of the invention.

### Example 1

### Preparation of Positive Electrode Plate

A positive electrode active material slurry was prepared by mixing 94 parts by mass of Li_{1.2}(Ni_{0.3}CO_{0.4}Mn_{0.3})O₂ as the positive electrode active material, 3 parts by mass of a carbon powder as a conductive agent, and 3 parts by mass of a polyvinylidene fluoride powder as a binder, and a N-methyl pyrrolidone (NMP) solution as a solvent. This positive electrode mixture slurry was coated on both surfaces of a positive electrode core with a thickness of 15 μm made of pure aluminum by the doctor blade method and dried to remove NMP as a solvent. After that, the resulting item was compressed with a compressing roller to prepare the positive electrode plate, with the positive electrode active material layer having a width of 150 mm by a height of 150 mm on one surface of the positive electrode core, and with an active material uncoated portion having a width of 30 mm by a height of 20 mm on the other surface. The thickness of the positive electrode active material layer (total value of both surfaces, X) was controlled to be 100 μm. Also, the area of the active material formed region of this positive electrode plate was 450 cm², and the ratio Y/X of (the thickness of the positive electrode core)/(thickness of the positive electrode active material layer) was 0.15.

### [Preparation of Negative Electrode Plate]

A negative electrode active material slurry was prepared by mixing 96 parts by mass of a graphite powder as the negative electrode active material, 2 parts by mass of carboxymethyl cellulose as a thickener, 2 parts by mass of styrene-butadiene rubber as a binder, and water as a solvent. This negative electrode mixture active material slurry was coated on both surfaces or one surface of a negative electrode core with a thickness of 10 μm made of copper by the doctor blade method and dried to remove water as a solvent. After that, the resulting item was compressed with a compressing roller to prepare the negative electrode plate, with the positive active material layer having a width of 155 mm by a height of 155 mm on one surface of the negative electrode core, and with an active material uncoated portion having a width of 30 mm by a height of 20 mm on the other surface.

### [Preparation of Separator]

Slurry was prepared by mixing 75 parts by mass, 25 parts by mass of polyvinyl alcohol (PVA) as a binder, and water. Then, the slurry was coated on one surface of polyethylene microporous film (the width 150 mm, the height 155 mm, the thickness 15 μm), and dried to form a metal oxide layer having a thickness of 5 μm.

### [Preparation of Stacked Electrode Assembly]

Twenty sheets of the above positive electrode plates and 21 sheets of the above negative electrode plates were alternately stacked interposing the separators therebetween. The above separators were disposed at the outmost surfaces in the stacked electrode assembly, and the stacked electrode assembly was fixed by insulation tapes 11. Therefore, the positive electrode active material formed area in the stacked electrode assembly was 9000 cm².

### [Preparation of Non-Aqueous Electrolyte]

Ethylene carbonate (EC) and diethyl carbonate (DEC) were mixed in the proportion of 25:75 by volume (25° C. and 1 atmosphere) to prepare a non-aqueous solvent. LiPF₆ as an electrolyte salt was dissolved to be 1.4 mol/L. Vinylene carbonate (VC) was added so as to provide the ratio of 1% by mass to the non-aqueous electrolyte solvent, and fluoroethylene carbonate was added so as to provide the ratio of 5% by mass to the non-aqueous electrolyte solvent to prepare the non-aqueous electrolyte.

### [Assembling of Battery]

Two aluminum laminated sheets were prepared which were constituted by stacking five layers: a dry laminate layer, an aluminum layer, a carboxylic acid-modified polypropylene layer, and a polypropylene layer. One of the laminated sheets was formed in a cup shape such that the polyamide layer was placed on the outside, thereby providing a housing space. Current collecting terminals (positive electrode: aluminum plate, negative electrode: cupper plate) were welded by ultrasonic welding to the positive and negative electrode tabs of the above electrode assembly. This electrode assembly was housed in the above housing space such that the positive and negative current collecting terminals projected from the aluminum laminated sheet. After that, the other laminated sheet was stacked on the electrode assembly, and the three sides except a side where the collecting terminals projected from the aluminum laminated sheet were thermally welded. The non-aqueous electrolyte prepared in the above method was injected through the one side which was not thermally welded, and by reducing the pressure, the electrode assembly was impregnated with the non-aqueous electrolyte. After that, the one side which had not been thermally welded was thermally welded to prepare the non-aqueous electrolyte secondary battery of example 1.

### Example 2

The non-aqueous electrolyte secondary battery of example 2 was prepared in the same way as example 1 except for using Li_{1.1}(Ni_{0.3}Co_{0.4}Mn_{0.3})O₂ as the positive electrode active material.

### Example 3

The non-aqueous electrolyte secondary battery of example 3 was prepared in the same way as example 1 except for using Li_{0.9}(Ni_{0.3}Co_{0.4}Mn_{0.3})O₂ as the positive electrode active material.

### Example 4

The non-aqueous electrolyte secondary battery of example 4 was prepared in the same way as example 1 except for using Li_{1.1}(Ni_{0.4}Co_{0.4}Mn_{0.2})O₂ as the positive electrode active material.

### Example 5

The non-aqueous electrolyte secondary battery of example 5 was prepared in the same way as example 1 except for using Li_{1.1}(Ni_{0.6}Co_{0.0}Mn_{0.3})O₂ as the positive electrode active material. Here, the description of Co_{0.0} means that cobalt was not contained in this positive electrode active material.

### Example 6

The non-aqueous electrolyte secondary battery of example 6 was prepared in the same way as example 1 except for using Li_{1.1}(Ni_{0.6}Co_{0.2}Mn_{0.2})O₂ as the positive electrode active material.

### Example 7

The non-aqueous electrolyte secondary battery of example 7 was prepared in the same way as example 1 except for using Li_{1.1}(Ni_{0.0}Co_{0.7}Mn_{0.3})O₂ as the positive electrode active material. Here, the description of Ni_{0.0} means that nickel was not contained in this positive electrode active material.

### Example 8

The non-aqueous electrolyte secondary battery of example 8 was prepared in the same way as example 1 except for using a mixture of Li_{1.1}(Ni_{0.3}Co_{0.4}Mn_{0.3})O₂ and Li_{1.1}Mn₂O₄ in the ratio by mass of 6:4 as the positive electrode active material.

### Example 9

The non-aqueous electrolyte secondary battery of example 9 was prepared in the same way as example 2 except for controlling the thickness of the positive electrode active material layer (total value of both surfaces, X) to be 65 μm. Then, the ratio Y/X of (the thickness of the positive electrode core)/(the thickness of the positive electrode active material layer) was 0.23.

### Example 10

The non-aqueous electrolyte secondary battery of example 10 was prepared in the same way as example 2 except for controlling the thickness of the positive electrode active material layer (total value of both surfaces, X) to be 75 μm. Then, the ratio Y/X of (the thickness of the positive electrode core)/(the thickness of the positive electrode active material layer) was 0.20.

### Example 11

The non-aqueous electrolyte secondary battery of example 11 was prepared in the same way as example 2 except for controlling the thickness of the positive electrode active material layer (total value of both surfaces, X) to be 150 μm. Then, the ratio Y/X of (the thickness of the positive electrode core)/(the thickness of the positive electrode active material layer) was 0.10.

### Example 12

The non-aqueous electrolyte secondary battery of example 12 was prepared in the same way as example 10 except for setting the thickness (Y) of the positive electrode core to be 12 μm. Then, the ratio Y/X of (the thickness of the positive electrode core)/(the thickness of the positive electrode active material layer) was 0.16.

### Example 13

The non-aqueous electrolyte secondary battery of example 13 was prepared in the same way as example 2 except for setting the thickness (Y) of the positive electrode core to be 12 μm. Then, the ratio Y/X of (the thickness of the positive electrode core)/(the thickness of the positive electrode active material layer) was 0.12.

### Example 14

The non-aqueous electrolyte secondary battery of example 14 was prepared in the same way as example 2 except for setting the thickness (Y) of the positive electrode core to be 13 μm and controlling the thickness of the positive electrode active material layer (total value of both surfaces, X) to be 65 μm. Then, the ratio Y/X of (the thickness of the positive electrode core)/(the thickness of the positive electrode active material layer) was 0.20.

### Example 15

The non-aqueous electrolyte secondary battery of example 15 was prepared in the same way as example 2 except for setting the thickness (Y) of the positive electrode core to be 20 μm. Then, the ratio Y/X of (the thickness of the positive electrode core)/(the thickness of the positive electrode active material layer) was 0.2.

### Example 16

The non-aqueous electrolyte secondary battery of example 16 was prepared in the same way as example 11 except for setting the thickness (Y) of the positive electrode core to be 25 μm. Then, the ratio Y/X of (the thickness of the positive electrode core)/(the thickness of the positive electrode active material layer) was 0.17.

### Example 17

The non-aqueous electrolyte secondary battery of example 17 was prepared in the same way as example 2 except for setting the thickness of the polyethylene microporous film in the separator to be 10 μm (15 μm in thickness of the separator).

### Example 18

The non-aqueous electrolyte secondary battery of example 18 was prepared in the same way as example 2 except for setting the thickness of the polyethylene microporous film in the separator to be 20 μm (25 μm in thickness of the separator).

### Example 19

The non-aqueous electrolyte secondary battery of example 19 was prepared in the same way as example 2 except for setting the thickness of the polyethylene microporous film in the separator to be 15 μm, setting the thickness of the metal oxide layer to be 3 μm, and setting the thickness of the separator to be 18 μm.

### Example 20

The non-aqueous electrolyte secondary battery of example 20 was prepared in the same way as example 2 except for setting the thickness of the polyethylene microporous film in the separator to be 15 μm and forming the metal oxide layer of 2.5 μm in thickness on the both surfaces of the polyethylene microporous film to set the thickness of the separator to be 20 μm.

### Example 21

The non-aqueous electrolyte secondary battery of example 21 was prepared in the same way as example 2 except for using the non-aqueous solvent in which ethylene carbonate (EC) and diethyl carbonate (DEC) were mixed in the proportion of 40:60 by volume (25° C. and 1 atmosphere).

### Example 22

The non-aqueous electrolyte secondary battery of example 22 was prepared in the same way as example 2 except for using the non-aqueous solvent in which ethylene carbonate (EC) and diethyl carbonate (DEC) were mixed in the proportion of 50:50 by volume (25° C. and 1 atmosphere).

### Example 23

The non-aqueous electrolyte secondary battery of example 23 was prepared in the same way as example 2 except for using the positive electrode plates with the positive electrode active material layer formed on both surfaces of the positive electrode core having a width of 100 mm by a height of 100 mm, the negative electrode plates with the negative electrode active material formed on both surfaces of the negative electrode core having a width of 105 mm by a height of 105 mm, and the separators having a width of 105 mm by a height of 105 mm. Then, since the positive electrode active material layer was formed on both surfaces of each of the positive electrode plates, the area of the positive electrode active material layer formed region was 200 cm² and the total area of the positive electrode active material layer formed region was 4000 cm².

### Example 24

The non-aqueous electrolyte secondary battery of example 24 was prepared in the same way as example 2 except for using the positive electrode plates with the positive electrode active material layer formed on both surfaces of the positive electrode core having a width of 200 mm by a height of 350 mm, the negative electrode plates with the negative electrode active material layer formed on both surfaces of the negative electrode core having a width of 205 mm by height of 355 mm, and the separators having a width of 205 mm by a height of 355 mm, and stacking 10 sheets of the positive electrode plates and 11 sheets of the negative electrode plates with the separators interposed therebetween. Then, the area of the positive electrode active material layer formed region was 1400 cm², and the total area of the positive electrode active material layer formed region was 14000 cm².

### Example 25

The non-aqueous electrolyte secondary battery of example 25 was prepared in the same way as example 24 except for changing the number of the positive electrode plates and the number of the negative electrode plates to 20 sheets and 21 sheets respectively. Then, the total area of the positive electrode active material layer was 28000 cm².

### Example 26

The non-aqueous electrolyte secondary battery of example 26 was prepared in the same way as example 24 except for changing the number of the positive electrode plates and the number of the negative electrode plates to 30 sheets and 31 sheets respectively. Then, the total area of the positive electrode active material layer was 42000 cm².

### Example 27

The non-aqueous electrolyte secondary battery of example 27 was prepared in the same way as example 1 except for using Li_{1.1}(Ni_{0.297}Co_{0.396}Mn_{0.297}Zr_{0.01})O₂ as the positive electrode active material.

### Example 28

The non-aqueous electrolyte secondary battery of example 28 was prepared in the same way as example 1 except for using Li_{1.1}(Ni_{0.294}Co_{0.392}Mn_{0.294}Zr_{0.01}W_{0.01})O₂ as the positive electrode active material.

### Comparative Example 1

The non-aqueous electrolyte secondary battery of comparative example 1 was prepared in the same way as example 1 except for using Li_{1.1}(Ni_{0.6}Co_{0.4}Mn_{0.0})O₂ as the positive electrode active material. Here, the description of Mn_{0.0} means that manganese was not contained in this positive electrode active material.

### Comparative Example 2

The non-aqueous electrolyte secondary battery of comparative example 2 was prepared in the same way as example 1 except for using Li_{1.1}(Ni_{0.8}Co_{0.2}Mn_{0.0})O₂ as the positive electrode active material.

### Comparative Example 3

The non-aqueous electrolyte secondary battery of comparative example 3 was prepared in the same way as example 1 except for using Li_{1.1}(Ni_{0.8}Co_{0.0}Mn_{0.2})O₂ as the positive electrode active material.

### Comparative Example 4

The non-aqueous electrolyte secondary battery of comparative example 4 was prepared in the same way as example 1 except for using Li_{1.1}CoO₂ as the positive electrode active material.

### Comparative Example 5

The non-aqueous electrolyte secondary battery of comparative example 5 was prepared in the same way as example 2 except for controlling the thickness of the positive electrode active material layer (total value of both surfaces, X) to be 50 μm. Then, the ratio Y/X of (the thickness of the positive electrode core)/(the thickness of the positive electrode active material layer) was 0.30.

### Comparative Example 6

The non-aqueous electrolyte secondary battery of comparative example 6 was prepared in the same way as example 2 except for setting the thickness (Y) of the positive electrode core to be 12 μm and controlling the thickness of the positive electrode active material layer (total value of both surfaces, X) to be 40 μm. Then, the ratio Y/X of (the thickness of the positive electrode core)/(the thickness of the positive electrode active material layer) was 0.30.

### Comparative Example 7

The non-aqueous electrolyte secondary battery of comparative example 7 was prepared in the same way as example 2 except for setting the thickness (Y) of the positive electrode core to be 30 μm. Then, the ratio Y/X of (the thickness of the positive electrode core)/(the thickness of the positive electrode active material layer) was 0.30.

### Comparative Example 8

The non-aqueous electrolyte secondary battery of comparative example 8 was prepared in the same way as example 2 except for using the polyethylene microporous film (15 μm in thickness) without the metal oxide layer formed.

### Comparative Example 9

The non-aqueous electrolyte secondary battery of comparative example 9 was prepared in the same way as example 2 except for using the polyethylene microporous film (20 μm in thickness) without the metal oxide layer formed.

### Comparative Example 10

The non-aqueous electrolyte secondary battery of comparative example 10 was prepared in the same way as example 2 except for using a prismatic outer can made of aluminum in place of the aluminum laminated sheet and sealing an opening of the prismatic outer case with a sealing body made of aluminum by laser (the configuration was employed in which the outer can worked as a positive electrode outer terminal and an outer terminal of the sealing body worked as a negative electrode outer terminal).

### Comparative Example 11

The non-aqueous electrolyte secondary battery of comparative example 11 was prepared in the same way as example 2 except for forming a cylindrical spiral electrode assembly by use of the elongated positive and negative electrode plates and the separator, and using a cylindrical outer can as an outer case in place of the aluminum laminated sheet. Here, the battery had the same design capacity as example 2 and a size of 10 mm in diameter and 65 mm in height.

### [Nail Penetration Test]

Three batteries in each of the above examples 1 to 28 and comparative examples 1 to 11 were prepared. Then, at 25° C. (degree Celsius) environment, the batteries were charged with a constant current of 1 lt until the voltage reached 4.3V, and subsequently, the batteries were charged with a constant voltage of 4.3 V until a charging current reached 0.02 lt. After that, at 60° C. environment, a nail having a 3 mm diameter was penetrated at the center portion in a wide surface of the battery in the vertical direction. Here, in comparative example 9 using the cylindrical outer can, the nail having the 3 mm diameter was penetrated at a side surface of the battery so as to penetrate the central axis of the battery. When, in any one of the three batteries, smoking or ignition occurs by the nail penetration, it was judged abnormal, and when no smoking or no burning occurs in all of the three batteries, it was judged normal. In addition, in each of the batteries of the examples 2, 21, and 22, the presence of the battery swell was visually observed. When the battery swell of about 1 mm or more was observed, it was judged that there was swell. In other cases, it was judged that there was no swell. The results were shown in Tables 1 to 9 described below.

TABLE 1

| | positive electrode active | nail penetration |
|---|---|---|
| | material composition | test |
| Example 1 | Li_{1.2}(Ni_{0.3}Co_{0.4}Mn_{0.3})O₂ | normal |
| Example 2 | Li_{1.1}(Ni_{0.3}Co_{0.4}Mn_{0.3})O₂ | normal |
| Example 3 | Li_{0.9}(Ni_{0.3}Co_{0.4}Mn_{0.3})O₂ | normal |
| Example 4 | Li_{1.1}(Ni_{0.4}Co_{0.4}Mn_{0.2})O₂ | normal |
| Example 5 | Li_{1.1}(Ni_{0.6}Co_{0.0}Mn_{0.4})O₂ | normal |
| Example 6 | Li_{1.1}(Ni_{0.6}Co_{0.2}Mn_{0.2})O₂ | normal |
| Example 7 | Li_{1.1}(Co_{0.7}Ni_{0.0}Mn_{0.3})O₂ | normal |
| Example 8 | Li_{1.1}(Ni_{0.3}Co_{0.4}Mn_{0.3})O₂ + Li_{1.1}Mn₂O₄ | normal |
| Com. Ex. 1 | Li_{1.1}(Ni_{0.6}Co_{0.4}Mn_{0.0})O₂ | abnormal |
| Com, Ex. 2 | Li_{1.1}(Ni_{0.8}Co_{0.2}Mn_{0.0})O₂ | abnormal |
| Com. Ex. 3 | Li_{1.1}(Ni_{0.8}Co_{0.0}Mn_{0.2})O₂ | abnormal |
| Com. Ex. 4 | Li_{1.1}CoO₂ | abnormal |

TABLE 2

| | thickness X of the | | | |
|---|---|---|---|---|
| | positive electrode | thickness Y of the | | nail |
| | active material | positive electrode | | penetration |
| | layer (μm) | core (μm) | Y/X | test |
| Com. Ex. 5 | 50 | 15 | 0.30 | abnormal |
| Example 9 | 65 | 15 | 0.23 | normal |
| Example 10 | 75 | 15 | 0.20 | normal |
| Example 2 | 100 | 15 | 0.15 | normal |
| Example 11 | 150 | 15 | 0.10 | normal |
| Com. Ex. 6 | 40 | 12 | 0.30 | abnormal |
| Example 12 | 75 | 12 | 0.16 | normal |
| Example 13 | 100 | 12 | 0.12 | normal |
| Example 14 | 65 | 13 | 0.20 | normal |
| Example 15 | 100 | 20 | 0.20 | normal |
| Com. Ex, 7 | 100 | 30 | 0.30 | abnormal |
| Example 16 | 150 | 25 | 0.17 | normal |

TABLE 3

| | | nail penetration |
|---|---|---|
| | separator | test |
| Com. Ex. 8 | no metal oxide composite | abnormal |
| | (thickness 15 μm) | |
| Com. Ex. 9 | no metal oxide composite | abnormal |
| | (thickness 20 μm) | |
| Example 2 | with metal oxide composite | normal |

TABLE 4

| | | | thickness of | |
|---|---|---|---|---|
| | separator | | polyethylene | nail |
| | thickness | oxide layer | microporous | penetration |
| | (μm) | thickness | film (μm) | test |
| Example 17 | 15 | one surface 5 μm | 10 | normal |
| Example 2 | 20 | one surface 5 μm | 15 | normal |
| Example 18 | 25 | one surface 5 μm | 20 | normal |
| Example 19 | 18 | one surface 3 μm | 15 | normal |
| Example 20 | 20 | both surfaces | 15 | normal |
| | | (one surface | | |
| | | 2.5 μm) | | |

TABLE 5

| | outer case | nail penetration test |
|---|---|---|
| Com. Ex. 10 | aluminum pnsmatic outer can | abnormal |
| Example 2 | aluminum laminated film | normal |

TABLE 6

| | EC proportion | nail penetration | battery state after |
|---|---|---|---|
| | (% by volume) | test | nail penetration test |
| Example 2 | 25 | normal | no swell |
| Example 21 | 40 | normal | no swell |
| Example 22 | 50 | normal | swell |

TABLE 7

| | electrode assembly | nail penetration test |
|---|---|---|
| Com. Ex. 11 | spiral type | abnormal |
| Example 2 | stacked type | normal |

TABLE 8

| | area of | number of | all area of | |
|---|---|---|---|---|
| | positive electrode | positive | positive | nail |
| | active material | electrode | electrode | penetra- |
| | layer per one | plates in | active material | tion |
| | sheet (cm²) | cell (sheets) | layer (cm²) | test |
| Example 23 | 200 | 20 | 4000 | normal |
| Example 24 | 1400 | 10 | 14000 | normal |
| Example 25 | 1400 | 20 | 28000 | normal |
| Example 25 | 1400 | 30 | 42000 | normal |
| Example 2 | 450 | 20 | 9000 | normal |

TABLE 9

| | | nail |
|---|---|---|
| | positive electrode active | penetration |
| | material composition | test |
| Example 2 | Li_{1.1}(Ni_{0.3}Co_{0.4}Mn_{0.3})O₂ | normal |
| Example 27 | Li_{1.1}(Ni_{0.297}Co_{0.396}Mn_{0.297}Zr_{0.01})O₂ | normal |
| Example 28 | Li_{1.1}(Ni_{0.294}Co_{0.392}Mn_{0.294}Zr_{0.01}W_{0.01})O₂ | normal |

The above table 1 shows that the nail penetration safety is excellent in the examples 1 to 7 using the positive electrode active material of the lithium transition-metal composite oxide expressed by Liₐ(Ni_{b}Co_{c}Mn_{d}Mₑ)O₂ (0.9≦a≦1.2, 0≦b≦0.6, 0.2≦d≦0.5, b+c+d+e=1, e=0 (in Table 1)), and the example 8 using the positive electrode active material of the mixture of the above lithium transition-metal composite oxide and the spinel type lithium manganese oxide.

On the contrary to this, in the comparative examples 1, 2, 4 using the positive electrode active material of the lithium transition-metal composite oxide containing no manganese, and the comparative example 3 of the nickel proportion b=0.8, it is understood that those were not enough in the nail penetration safety.

The reason for this is probably as follows. Any lithium transition-metal composite oxide expressed by Liₐ(Ni_{b}Co_{c}Mn_{d}Mₑ)O₂ (0.9≦a≦1.2, 0≦b≦0.6, 0.2≦d≦0.5, 0≦e≦0.05, b+c+d+e=1, e=0 (in Table 1)) is excellent in thermal stability and resistance to a short circuit, and shows high safety in the nail penetration test. In addition, also the spinel type lithium manganese oxide is excellent in thermal stability and resistance to the short circuit, and even the mixture of this and the above lithium transition-metal composite oxide shows high safety in the nail penetration test.

However, when the content of manganese is too low, the lithium transition-metal composite oxide shows insufficient thermal stability, resulting in insufficient safety during the nail penetration. When the content of the manganese is too high, the short circuit reaction during the nail penetration tends to proceed rapidly, resulting in insufficient safety during the nail penetration.

Further, in any of the examples 5 and 7 using the positive electrode active material of the lithium transition-metal composite oxide which does not contains either nickel or cobalt, and the examples 1 to 3 with the lithium contents a of 0.9 to 1.2, the safety during the nail penetration is sufficient.

In addition, the above Table 2 shows that the nail penetration safety is excellent in the examples 2 and 9 to 16 in which Y/X is 0.23 or less in the ratio Y/X of the thickness Y of the positive electrode core to the thickness X of the positive electrode active material layer. In contrast, it is found that the safety during the nail penetration is insufficient those are not enough in the nail penetration safety in the comparative 5 and 6 in which Y/X is more than 0.23.

The reason for this is probably as follows. When the thickness of the positive electrode core is larger than that of the positive electrode active material layer, a large current flows at the time of the compulsory short circuit like the nail penetration, resulting in the decrease in safety. Therefore, at the ratio Y/X of the thickness Y of the positive electrode core to the thickness X of the positive electrode active material layer is 0.23 or less. In consideration of the balance between the thickness Y of the positive electrode core and the thickness X of the positive electrode active material layer, the ratio Y/X is more preferably 0.20 or less.

Further, the above Table 3 shows that while the example 2 in which the metal oxide layer is formed on the separator is excellent in the nail penetration safety, the comparative examples 8 and 9 in which the metal oxide layer is not formed on the separator is insufficient in the nail penetration safety.

The reason for this is probably as follows. The polyolefin microporous film thermally contracts, when it is heated to high temperatures. However, when the metal oxide layer is formed on the separator, the metal oxide layer works so as to suppress the thermal contraction. Although the contraction of the separator leads to the short circuit by the contact between the positive and negative electrode plates to decrease safety (refer to the comparative examples 8 and 9), the metal oxide layer formed on the separator prevents such short circuit, resulting in enhancement of the safety during the battery abnormality like the nail penetration (refer to the example 2).

Further, the above Table 4 shows that when the layer of metal oxide composite is formed in on the separator, the safety during the nail penetration is excellent regardless of the thickness of the separator (refer to the example 2 and 17 to 20).

Further, the above Table 5 shows that while the example 2 using the aluminum laminated film as the outer case is excellent in the safety of during the nail penetration, the comparative example 10 using the prismatic outer can made of aluminum is insufficient in the safety during the nail penetration

The reason for this is probably as follows. For the outer case of the aluminum laminated sheet, the positive and negative electrode plates are not electrically connected to the outer case. In contrast, for the comparative example 10, the outer can also works as the positive electrode outer terminal (the outer can is electrically connected to the positive electrode). When the outer can is electrically connected to the positive electrode, the temperature of the positive electrode easily increases at the time of the nail penetration. Therefore, even when the above lithium transition metal composite oxide is used as the positive electrode active material, the thermal stability is decreased and the safety is not ensured. Here, when the outer can is electrically connected to the negative electrode or the outer can has no polarity, such problem does not occur.

Further, the above Table 6 shows that even though the content of ethylene carbonate (EC) contained in the non-aqueous solvent is increased, it has no influence on safety during the nail penetration. In addition, in the example 22 in which the content of EC is 50% by volume, the large battery swell after the nail penetration test was observed compared with the examples 2 and 21 having the EC contents of 25 to 40% by volume.

The reason for this is probably as follows. The above lithium transition-metal composite oxide easily reacts with ethylene carbonate (EC) under high temperature conditions, and gas is generated by reaction, resulting in the battery swell. Therefore, when ethylene carbonate (EC) is contained, the content of ethylene carbonate (EC) to the non-aqueous solvent is 40% by volume or less. Here, by containing ethylene carbonate (EC), discharge characteristics are improved.

Further, the above Table 7 shows the case with the use of the spiral electrode assembly (the comparative example 11) cannot ensure the nail penetration safety even when other conditions, such as the positive electrode active material, the non-aqueous solvent, and the metal oxide layer, are the same as the case with the use of the stacked electrode assembly (the example 2).

The reason for this is probably as follows. At the time of the compulsory short circuit by the nail penetration, the short-circuit current mainly flows at the location where the nail is penetrated, and a part of the current flows via other conducting portions of the electrode plate as bypass current paths. For the stacked electrode assembly, the bypass current flows via narrow tabs which are connected to the electrode outer terminal. For the spiral electrode assembly, the bypass current flows via wound wide positive and negative electrode cores. Therefore, the bypass current of the spiral electrode assembly is larger than that of the stacked electrode assembly, and the larger current flows in the spiral electrode during the penetration, causing insufficient safety.

In addition, probably, because the spiral electrode assembly has distortions by expansion and contraction in charging and discharging, tabs, and the like within the spiral structure, the large-area (multipoint) short circuit by those edges in the vicinity of the short-circuit portion easily occurs.

Further, the above Table 7 shows that the safety can be maintained even in the large battery having a large area and capacity in which the area of the positive electrode active material layer is 200 cm² or more, and the total area of the regions with the positive electrode active material layer each formed is 4000 cm² or more.

Further, the above Table 8 shows that the similar results are obtained regardless of the addition of element M to the positive electrode active material, and the similar effects are obtained in the any case with the use of the lithium transition-metal composite oxide expressed by Liₐ(Ni_{b}Co_{c}Mn_{d}Mₑ)O₂ (M is at least one element selected from the group consisting of Ti, Nb, Mo, Zn, Al, Sn, Mg, Ca, Sr, Zr, and W, and the proportion e is 0≦e≦0.05).

### [Additional Matters]

Here, the nonaqueous solvent used for the nonaqueous electrolyte includes carbonates, lactones, ketones, ethers, and esters. Specifically, ethylene carbonate (EC), propylene carbonate (PC), butylene carbonate (BC), diethyl carbonate (DEC), ethyl methyl carbonate (EMC), dimethyl carbonate (DMC), γ-butyrolactone, γ-valerolactone, γ-dimethoxyethane, tetrahydrofuran, 1,4-dioxane, and the like can be used.

Further, the electrolyte salt used for the non-aqueous electrolyte, besides LiPF₆ used above, includes one kind or a mixture of two or more of LiBF₄, LiAsF₆, LiCF₃SO₃, LiN(CF₃SO₂)₂, LiN(C₂F₅SO₂)₂, and LiClO₄. The amount of electrolyte salt dissolved in the non-aqueous solvent is preferably 0.5 to 2.0 mol/L.

Further, the negative electrode active material, besides graphite, includes one kind or a mixture of two or more of carbonaceous material capable of absorbing and desorbing lithium ions (for example, acetylene black, carbon black, amorphous carbon), silicon material, metal lithium, lithium alloy, and metal oxide capable of absorbing and desorbing lithium ions.

Further, the polyolefin microporous film is used as the separator. As the polyolefin, polyethylene, or polypropylene is preferably used. In addition, a microporous film of a mixture of polyethylene and polypropylene can be used. Moreover, a stacked microporous film of polyethylene and polypropylene can be used.

Here, a safety mechanism is not an essential component of the present invention. However, the safety mechanism, in which the increase in the inner pressure of the battery leads to the interruption of a current flow and the discharge of the gas, can further enhance the battery safety. As the safety mechanism, for example, valve members having a film shape or having a notch shape (groove shape) can be used which are attached to the sealing portion of the battery or formed on the outer can and are broken by the increase in the inner pressure of the battery.

### INDUSTRIAL APPLICABILITY

As explained above, the present invention can provide a non-aqueous electrolyte secondary battery which has a high capacity and is excellent in safety. The industrial applicability is significant.

1. A non-aqueous electrolyte secondary battery comprising:
a stacked electrode assembly in which plural positive electrode plates and plural negative electrode plates are stacked interposing separators therebetween; and
an outer case storing a non-aqueous electrolyte and the stacked electrode assembly,
wherein:
each of the positive electrode plates is provided with a positive electrode active material layer formed on a surface of a positive electrode core made of an aluminum-based metal;
the separator comprises a polyolefin microporous film and a layer containing insulating metal oxide which is formed on at least one surface of the polyolefin microporous film;
the positive electrode active material layer comprises a lithium transition-metal composite oxide expressed by Liₐ(Ni_{b}Co_{c}Mn_{d}Mₑ)O₂ (0.9≦a≦1.2, 0≦b≦0.6, 0.2≦d≦0.5, 0≦e≦0.05, b+c+d+e=1, and M is at least one element selected from the group consisting of Ti, Nb, Mo, Zn, Al, Sn, Mg, Ca, Sr, Zr, and W) as the positive electrode active material;
a thickness X of the positive electrode active material layer and a thickness Y of the positive electrode core satisfy a relation of Y/X≦0.23; and
the outer case is not electrically connected to the positive electrode plates.

2. The non-aqueous electrolyte secondary battery according to claim 1,
wherein a region in the each positive electrode plate, where the positive electrode active material layer is formed, has an area of 200 cm² or more.

3. The non-aqueous electrolyte secondary battery according to claim 1,
wherein the regions in the plural positive electrode plates, where the positive electrode active material layer is each formed, have a total area of 4000 cm² or more.

4. The non-aqueous electrolyte secondary battery according to claim 1,
wherein the non-aqueous electrolyte contains a non-aqueous solvent, and the non-aqueous solvent contains 40% or less by volume of ethylene carbonate to the non-aqueous solvent.

5. The non-aqueous electrolyte secondary battery according to claim 1,
wherein the non-aqueous electrolyte contains 0.5 to 10% by mass of fluoroethylene carbonate to the non-aqueous electrolyte.

6. The non-aqueous electrolyte secondary battery according to claim 1,
wherein the positive electrode core has a thickness of 12 to 25 μm.

7. The non-aqueous electrolyte secondary battery according to claim 1,
wherein the outer case is made of a laminated film in which a resin layer are formed on both surfaces of a metal foil.

8. The non-aqueous electrolyte secondary battery according to claim 1,
wherein the positive electrode active material further contains a spinel type lithium manganese oxide expressed by Li_{f}Mn_{2-g} M1_{g}O₄ (0.9≦f≦1.2, 0≦g≦0.1, and M1 is at least one element selected from the group consisting of B, Mg, Ca, Sr, Ba, Ti, Ni, Al, Nb, Mo, W, Y, and Rh).

9. The non-aqueous electrolyte secondary battery according to claim 1,
wherein the thickness X of the positive electrode active material layer and the thickness Y of the positive electrode core satisfy a relation of Y/X≦0.20.
